(19) United States
(12) Patent Application Publication
(10) Pub. No.: US 2024/0370235 A1
(43) Pub. Date: Nov. 7, 2024

(54) COMPUTER-IMPLEMENTED SYSTEM AND METHOD FOR GENERATING SOFTWARE ARCHITECTURE IN AN EDGE COMPUTING NETWORK BASED ON A DESIGN STUDIO APPLICATION

(71) Applicant: Pratexo, Inc., Austin, TX (US)

(72) Inventors: Peter Norwood, Austin, TX (US); Petter Graff, Austin, TX (US)

(21) Appl. No.: 18/652,828

(22) Filed: May 2, 2024

Related U.S. Application Data
(60) Provisional application No. 63/499,498, filed on May 2, 2023.

(51) Int. Cl. G06F 8/34

(52) U.S. Cl. CPC G06F 8/34

(57) ABSTRACT

A computer-implemented method and system for generating software architecture in an edge computing network based on a design studio application, is disclosed. The computer-implemented method includes: receiving inputs from electronic devices associated with users to select components; categorizing components to break down the components into categories for search options; positioning the selected components on canvas using drag and drop capability of the design studio application; analyzing properties associated with the components to configure the edge computing network based on properties panels in GUI for each component; creating the routes by creating a line between icons corresponding to the components, on the canvas, to establish connections between components; generating the software architecture upon creation of routes between the components; processing the generated software architecture to generate installation plans and automatically create corresponding scripts, for installing the software architecture; and providing an output of the generated software architecture.

### CROSS REFERENCE TO RELATED APPLICATION(S)

This application claims the priority to incorporates by reference the entire disclosure of U.S. provisional patent application No. 63/499,498 filed on May 2, 2023 titled “A DESIGN STUDIO PLATFORM TO DESIGN AND DEPLOY SOFTWARE RUNNING ON AN EDGE COMPUTING NETWORK”.

### FIELD OF INVENTION

Embodiments of the present disclosure relate to generation of software running on edge computing networks and more particularly relates to a computer-implemented system and method for generating software architecture in an edge computing network based on a design studio application.

### BACKGROUND

Recent advancements in technology have led to the development of applications that run in cloud computing environments managed by a third party such as Azure, AWS, and Google. The applications that run on cloud-based computing environments can leverage capabilities provided by the cloud computing environment that simplify the design and deployment of the application. The cloud computing environments provide multiple services by using various Application Program Interfaces (APIs). Additionally, the cloud computing environments also provide an orchestration platform that make it easy to deploy the application onto a large number of compute nodes in the cloud and to scale the application to run on more compute nodes to meet the requirement for the application to extend to new geographies or to scale its performance capabilities. The cloud computing environment provides benefits to the applications including scalability, resilience to failures, and distributed computing by running applications that span multiple compute nodes and data stores.

IoT (Internet of Things) applications are configured to manage equipment in geographically distributed environments. Managing the equipment means collecting data, both forensically and in real time, from one or more sensors that are connected to the equipment in order to perform predictive maintenance or process optimization. The IoT applications monitor the equipment, detect anomalous conditions, alert to failures in the equipment. The IoT applications also often involve controlling the equipment by sending data to actuators connected to the equipment. For many companies and institutions, the equipment is not always in one central location but is instead distributed geographically and the equipment is therefore remote from the data center that hosts the application. These IoT applications manage the equipment by communicating from a central data center to each of the pieces of equipment's sensors and actuators directly or by connecting through simple controllers co-located with the equipment, e.g. PLC's (Programmable Logic Controllers) that act as an interface to the sensors and actuators. However, it is often important for applications to split their computational logic across the central data center and the remote locations. This requires putting computers out in the distributed locations near the equipment. This is required to reduce the bandwidth of data collected from the equipment by only sending an important subset of data upstream from the equipment whenever important events are detected. It is also required to allow for reducing latency in reacting to certain conditions detected in the equipment. This can best be accomplished splitting the application and allowing some of analytics and business logic to run at “the edge” in compute nodes co-located with the equipment. This new type of application that splits its computational load across the central data center and the remote distributed locations (referred to as “the edge”) are called Edge-to-Cloud (“E2C”) applications because they split the computation across the central data center and the edge compute nodes.

E2C applications are often tiered with different software executing on different sets of compute nodes. For example, E2C applications often require an aggregation of data and decision making in a centralized location. It is often valuable to have a global view of distributed operations by creating a global dashboard. It is also often valuable to aggregate the data from distributed equipment to allow analytics to analyze data across many pieces of equipment rather than only a single piece of equipment. However, sometimes the E2C applications must omit the public cloud tier and must operate solely at the edge without any computation running in a central cloud. This is often the case when there is a requirement to not share data with a public cloud or when connectivity to a central cloud cannot be ensured. Sometimes this means the function of the public cloud is assumed by another tier of computation placed in an on-premise cloud running in a data center that can be disconnected from the public Internet. Sometimes the E2C application may also have a requirement to only operate without the on premise tier so that the E2C application operates only at the edge, in which case the role of the software roles typically running in the public cloud or on premises are run on the edge compute nodes themselves.

Further, generating an E2C application is more complex than writing a traditional IoT application because it involves splitting the application across a set of compute nodes that spans a combination of compute nodes running in virtual machines in the public cloud (e.g. hosted cloud platforms from Google, Amazon, and Microsoft) or on-premise clouds running on compute nodes in centralized data centers, and edge compute nodes running in the field in distributed locations. Such a distributed E2C application requires specification of what software components (“features”) will run in each of the different environments, how those features will be configured, how they will communicate with each other, and how they will be installed.

Hence, there is a need for an improved computer-implemented system and method for generating E2C applications across public clouds, on-premise data centers and edge computing networks, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computer-implemented method for generating software architecture in an edge computing network based on a design studio application, is disclosed. The computer-implemented method comprises receiving, by one or more hardware processors, one or more inputs from one or more electronic devices associated with one or more users to select one or more components for generating the software architecture in the edge computing network. The one or more components comprise at least one of: one or more physical devices, one or more groups of one or more edge computing nodes performing identical roles in the software architecture, one or more features, one or more categories of the one or more features, one or more configurations of the one or more features, one or more routes indicating one or more connections between the one or more features for communicating with each feature, and one or more clouds configured across the one or more groups of the one or more edge computing nodes.

The computer-implemented method further comprises generating, by the one or more hardware processors, the software architecture in the edge computing network based on the selected one or more components. For generating the software architecture in the edge computing network based on the selected one or more components comprises, the computer-implemented method comprises categorizing, by the one or more hardware processors, the one or more components to break down the one or more components into one or more categories for search options. The one or more components comprise one or more icons corresponding to the one or more components for dragging and dropping the one or more components within the edge computing network.

For generating the software architecture in the edge computing network based on the selected one or more components comprises, the computer-implemented method further comprises positioning, by the one or more hardware processors, the selected one or more components on one or more canvas using a drag and drop capability of the design studio application. For generating the software architecture in the edge computing network based on the selected one or more components comprises, the computer-implemented method further comprises analyzing, by the one or more hardware processors, one or more properties associated with the one or more components to configure the edge computing network based on one or more properties panels in a graphical user interface for each of the one or more components. For generating the software architecture in the edge computing network based on the selected one or more components comprises, the computer-implemented method further comprises creating, by the one or more hardware processors, the one or more routes by creating a line between two or more icons corresponding to the one or more components, on the one or more canvas, to establish one or more connections between two or more components. The one or more routes indicate one or more communication paths between the two or more components. For generating the software architecture in the edge computing network based on the selected one or more components comprises, the computer-implemented method further comprises generating, by the one or more hardware processors, the software architecture in the edge computing network upon creation of the one or more routes between the two or more components.

The computer-implemented method further comprises processing, by the one or more hardware processors, the generated software architecture in the edge computing network to generate one or more installation plans and automatically create corresponding scripts, for installing the software architecture.

The computer-implemented method further comprises executing, by the one or more hardware processors, the generated software architecture in the edge computing network based on at least one of: a simulation-based execution and a physical-based execution.

The computer-implemented method further comprises providing, by the one or more hardware processors, an output of at least one of: installation progress and installation status, one or more properties, one or more configuration details, and functioning status, of the generated software architecture, on the graphical user interface associated with the one or more electronic devices associated with the one or more users.

In an embodiment, the computer-implemented method further comprises displaying, by the one or more hardware processors, the one or more properties associated with the selected one or more components for configuring the one or more components to obtain an optimized edge computing network.

In another embodiment, the computer-implemented method further comprises updating, by the one or more hardware processors, one or more configurations of the edge computing network based on the analysis of the one or more properties associated with the one or more components, upon selecting the one or more components.

In yet another embodiment, the computer-implemented method further comprises at least one of: (a) configuring, by the one or more hardware processors, each endpoint of the one or more routes to indicate a way in which each component receives one or more information from the one or more components; and (b) configuring, by the one or more hardware processors, each endpoint of the one or more routes to indicate the way in which each component transmits the one or more information to the one or more components.

In yet another embodiment, the computer-implemented method further comprises storing, by the one or more hardware processors, the generated software architecture upon completion of the generation process of the software architecture. The generated software architecture is configured as a reference software architecture for creating one or more identical variants of the software architecture to support one or more identical configurations.

In yet another embodiment, executing, by the one or more hardware processors, the generated software architecture in the edge computing network based on the simulation-based execution, comprises: (a) receiving, by the one or more hardware processors, one or more information associated with at least one of: number of one or more virtual machines and type of the one or more virtual machines, to create each group of the one or more edge computing nodes; (b) executing, by the one or more hardware processors, the generated software architecture onto the one or more virtual machines; (c) utilizing, by the one or more hardware processors, the one or more installation plans to install the generated software architecture, onto the one or more virtual machines; and (d) generating, by the one or more hardware processors, one or more statuses for one or more phases of the virtual execution of the generated software architecture.

In yet another embodiment, executing, by the one or more hardware processors, the generated software architecture in the edge computing network based on the physical-based execution, comprises: (a) receiving, by the one or more hardware processors, one or more information associated with at least one of: number of one or more physical devices and type of the one or more physical devices, to create each group of the one or more edge computing nodes; (b) receiving, by the one or more hardware processors, one or more information associated with at least one of: the one or more physical devices, a set of protocols to be followed for configuration, one or more device addresses, and one or more configuration parameters, to connect to the one or more physical devices; (c) executing, by the one or more hardware processors, the generated software architecture onto the one or more physical devices; (d) utilizing, by the one or more hardware processors, the one or more installation plans to install the generated software architecture, onto the one or more physical devices; and (e) generating, by the one or more hardware processors, one or more statuses for one or more phases of the physical execution of the generated software architecture.

In one aspect, a computer-implemented system for generating software architecture in an edge computing network based on a design studio application, is disclosed. The computer-implemented system includes one or more hardware processors and a memory coupled to the one or more hardware processors. The memory includes a plurality of subsystems in the form of programmable instructions executable by the one or more hardware processors.

The plurality of subsystems comprises an input receiving subsystem configured to receive one or more inputs from one or more electronic devices associated with one or more users to select one or more components for generating the software architecture in the edge computing network. The one or more components comprise one or more physical devices, one or more groups of one or more edge computing nodes performing identical roles in the software architecture, one or more features, one or more categories of the one or more features, one or more configurations of the one or more features, one or more routes indicating one or more connections between the one or more features for communicating with each feature, and one or more clouds configured across the one or more groups of the one or more edge computing nodes.

The plurality of subsystems further comprises a software architecture generation subsystem configured to generate software architecture. For generating software architecture in the edge computing network based on the one or more components, the software architecture generation subsystem is configured to categorize the one or more components to break down the one or more components into one or more categories for search options. The one or more components comprise one or more icons corresponding to the one or more components for dragging and dropping the one or more components within the edge computing network.

For generating software architecture in the edge computing network based on the one or more components, the software architecture generation subsystem is further configured to position the selected one or more components on one or more canvas using a drag and drop capability of the design studio application. For generating software architecture in the edge computing network based on the one or more components, the software architecture generation subsystem is further configured to analyze one or more properties associated with the one or more components to configure the edge computing network based on one or more properties panels in a graphical user interface for each of the one or more components.

For generating software architecture in the edge computing network based on the one or more components, the software architecture generation subsystem is further configured to create the one or more routes by creating a line between two or more icons corresponding to the one or more components, on the one or more canvas, to establish one or more connections between two or more components. The one or more routes indicate one or more communication paths between the two or more components.

For generating software architecture in the edge computing network based on the one or more components, the software architecture generation subsystem is further configured to generate the software architecture in the edge computing network upon creation of the one or more routes between the two or more components.

The plurality of subsystems further comprises a software architecture processing subsystem configured to process the generated software architecture in the edge computing network to generate one or more installation plans and automatically create corresponding scripts, for installing the software architecture.

The plurality of subsystems further comprises a software architecture execution subsystem configured to execute the generated software architecture in the edge computing network based on at least one of: a simulation-based execution and a physical-based execution.

The plurality of subsystems further comprises an output subsystem configured to provide an output of at least one of: installation progress and installation status, one or more properties, one or more configuration details, and functioning status, of the generated software architecture, on the graphical user interface associated with the one or more electronic devices associated with the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary networking environment of a computer-implemented system for generating the software architecture of the software running on the edge computing network based on a design studio application, in accordance with an embodiment of the present disclosure;

FIG. 2 is a detailed view of the design studio application for generating the software architecture of the software running on an edge computing network, in accordance with an embodiment of the present disclosure;

FIG. 3 is a diagrammatic illustration of an exemplary Graphical User Interface (GUI) screen of the design studio application, in accordance with an embodiment of the present disclosure;

FIG. 4 is a flow chart illustrating a computer-implemented method for generating the software architecture of the software running on the edge computing network based on the design studio application, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

In the present invention, the term design studio application 102 refers to at least one of: a software, system, framework, application, tool, and the like. The terms software, system, framework, application, or tool are often used interchangeably and are described as a set of computer programs that accomplishes a specific task. In the present invention, the specific task includes facilitating the designing and deployment of a software architecture for an edge computing network.

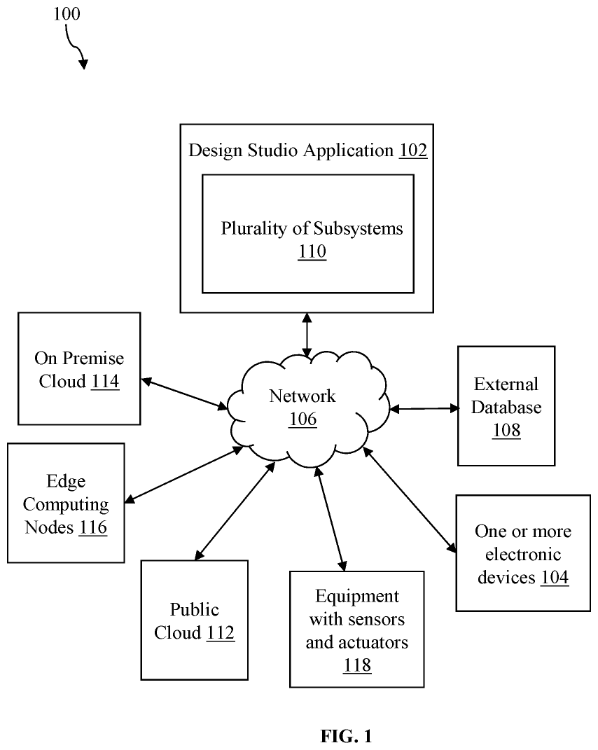

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

FIG. 1 is a block diagram illustrating an exemplary networking environment 100 of a computer-implemented system for generating the software architecture of the software running on the edge computing network based on a design studio application 102, in accordance with an embodiment of the present disclosure. According to FIG. 1, the networking environment 100 includes one or more electronic devices 104 and the design studio application 102 communicatively coupled to an external database 108 via a network 106. The one or more electronic devices 104 are associated with one or more users. The design studio application 102 includes a plurality of subsystems 110. The design studio application 102 may be configured in at least one of: a public cloud 112, on premise cloud 114, that are run on one or more edge compute nodes 116. In an embodiment, the design studio application 102 may be configured for an equipment 118 including at least one of: one or more sensors and one or more actuators.

Further, the network 106 may be a Wireless Fidelity (Wi-Fi) connection, a hotspot connection, a Bluetooth connection, a local area network, a wide area network, or any other wireless network. In an exemplary embodiment of the present disclosure, the one or more electronic devices 104 may include a laptop computer, desktop computer, tablet computer, smartphone, wearable device, smart watch, and the like.

The external database 108 includes relevant details of one or more components, configuration details, individual deployment/execution status details of the edge computing network, and the like. Furthermore, the one or more electronic devices 104 include a local browser, a mobile application, or a combination thereof. Furthermore, the one or more users may use a web application via the local browser, the mobile application, or a combination thereof to communicate with the design studio application 102.

The design studio application 102 including the plurality of subsystems 110 presents a Graphical User Interface (GUI) to the one or more users for making the computer-implemented system easy and fast for the one or more users to generate and execute the software architecture of the software running on the edge computing network. The GUI includes a work area made up of the plurality of subsystems 110 used to select the one or more components and organize the one or more components for generating the software architecture in the edge computing network. The GUI mimics the offline procedure of using a white board to draw out the design and software architecture of the edge computing network.

The design studio application 102 is initially configured to receive one or more inputs from the one or more electronic devices 104 associated with the one or more users to select the one or more components for generating the software architecture in the edge computing network. In an embodiment, the one or more components may include at least one of: one or more physical devices, one or more groups of one or more edge computing nodes performing identical roles in the software architecture, one or more features, one or more categories of the one or more features, one or more configurations of the one or more features, one or more routes indicating one or more connections between the one or more features for communicating with each feature, and one or more clouds configured across the one or more groups of the one or more edge computing nodes. In an embodiment, the one or more categories of the one or more features may include at least one of: one or more databases, one or more monitoring systems, one or more storage systems, one or more device connectivity protocols, one or more messaging systems, one or more analytics modules, one or more visualization systems, and the like. In an embodiment, the design studio application 102 may be configured to provide the ability to generate one or more custom categories of the one or more features.

The design studio application 102 is further configured to generate the software architecture in the edge computing network based on the selected one or more components. For generating the software architecture in the edge computing network, the design studio application 102 is configured to categorize the one or more components to break down the one or more components into one or more categories for search options. In an embodiment, the one or more components may include one or more icons corresponding to the one or more components for dragging and dropping the one or more components within the edge computing network.

The design studio application 102 is further configured to position the selected one or more components on one or more canvas using a drag and drop capability of the design studio application 102. The design studio application 102 is further configured to analyze one or more properties associated with the one or more components to configure the edge computing network based on one or more properties panels in a graphical user interface for each of the one or more components. The design studio application 102 is further configured to create the one or more routes by creating a line between two or more icons corresponding to the one or more components, on the one or more canvas, to establish one or more connections between two or more components. The one or more routes may indicate one or more communication paths between the two or more components. The design studio application 102 is further configured to generate the software architecture in the edge computing network upon creation of the one or more routes between the two or more components.

The design studio application 102 is configured to process the generated software architecture in the edge computing network to generate one or more installation plans and automatically create corresponding scripts, for installing the software architecture. The design studio application 102 is further configured to execute/deploy the generated software architecture in the edge computing network based on at least one of: a simulation-based execution and a physical-based execution. The design studio application 102 is further configured to provide an output of at least one of: installation progress and installation status, one or more properties, one or more configuration details, and functioning status, of the generated software architecture, on the graphical user interface associated with the one or more electronic devices 104 associated with the one or more users.

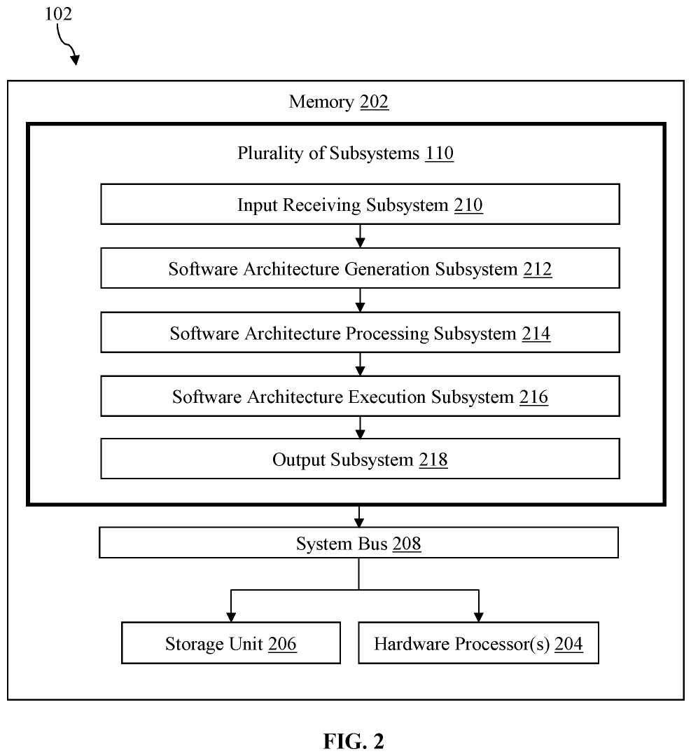

The details of the design studio application 102 inclusive of the plurality of subsystems 110 have been elaborated in subsequent paragraphs of the present description with reference to FIG. 2.

FIG. 2 is a detailed view of the design studio application 102 for generating the software architecture of the software running on an edge computing network, in accordance with an embodiment of the present disclosure. The design studio application 102 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes an input receiving subsystem 210, a software architecture generation subsystem 212, a software architecture processing subsystem 214, a software architecture execution subsystem 216, and an output subsystem 218.

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 110.

The design studio application 102 enables the one or more users to either generate a new software architecture or edit an existing and previously saved reference software architecture saving enormous time and effort of the one or more users, especially when applying a particular software architecture for multiple use cases. Further, the design studio application 102 presents the GUI to the one or more users making the computer-implemented system user-friendly and feasible for the one or more users to generate the software architecture of the software running on the edge computing network.

The plurality of subsystems 110 includes the input receiving subsystem 210 that is communicatively connected to the one or more hardware processors 204. The input receiving subsystem 210 is configured to receive the one or more inputs from the one or more electronic devices 104 associated with the one or more users. In an embodiment, the one or more components may include at least one of: the one or more physical devices, the one or more groups of the one or more edge computing nodes performing identical roles in the software architecture, the one or more features, the one or more categories of the one or more features, the one or more configurations of the one or more features, the one or more routes indicating the one or more connections between the one or more features for communicating with each feature, and the one or more clouds configured across the one or more groups of the one or more edge computing nodes. In an embodiment, the one or more categories of the one or more features may include at least one of: the one or more databases, the one or more monitoring systems, the one or more storage systems, the one or more device connectivity protocols, the one or more messaging systems, the one or more analytics modules, the one or more visualization systems, and the like. In an embodiment, the design studio application 102 may be configured to provide the ability to generate the one or more custom categories of the one or more features.

In an embodiment, the one or more physical devices may include one or more sensors that collect data and one or more actuators that perform actions in response to the one or more inputs. The one or more physical devices may be selected from a group comprising at least one of: power multi-meter, voltmeter, ampere meter, energy meter, SCADA device, temperature sensor, humidity meter, vibration meter, level meter, and the like. In an embodiment, the one or more groups of one or more edge computing nodes may perform the identical role in the software architecture, for example, collecting and analyzing data from the one or more components.

In an embodiment, the one or more features may correspond to at least one of but not limited to, a middleware component such as a queuing system, database, an application-level component such as a Python program, an analytics program, a machine learning model, and the like. In an embodiment, the one or more routes may indicate the one or more connections between the one or more features for communicating with each other. In an embodiment, the one or more clouds are deployed across the one or more groups of the one or more edge computing nodes that include the one or more features installed as a part of the one or more clouds.

The plurality of subsystems 110 includes the software architecture generation subsystem 212 that is communicatively connected to the one or more hardware processors 204. The software architecture generation subsystem 212 is configured to generate the software architecture in the edge computing network based on the selected one or more components. For generating the software architecture in the edge computing network, the software architecture generation subsystem 212 is configured to categorize the one or more components to break down the one or more components into one or more categories for search options. In an embodiment, the one or more components are categorized in list of the Graphical User Interface (GUI) screen associated with the one or more electronic devices 104 associated with the one or more users. For example, the one or more features may have subcategories for several types of features including at least one of: device connectors, databases, and the like. In an embodiment, the one or more components may include the one or more icons corresponding to the one or more components for dragging and dropping the one or more components within the edge computing network.

For generating the software architecture in the edge computing network, the software architecture generation subsystem 212 is further configured to position the selected one or more components on the one or more canvas using the drag and drop capability of the design studio application 102, based on the received one or more inputs of the selected one or more components by the one or more users. For generating the software architecture in the edge computing network, the software architecture generation subsystem 212 is further configured to display the one or more properties associated with the selected one or more components for configuring the one or more components to obtain an optimized (i.e., high precise) edge computing network.

For generating the software architecture in the edge computing network, the software architecture generation subsystem 212 is further configured to analyze the one or more properties associated with the one or more components to configure the edge computing network based on one or more properties panels in the graphical user interface for each of the one or more components. For generating the software architecture in the edge computing network, the software architecture generation subsystem 212 is further configured to update one or more configurations of the edge computing network based on the analysis of the one or more properties associated with the one or more components, upon selection of the one or more components. In an embodiment, a key point of the design studio application 102 is to generate/update n-number of configurations based on permutations and combinations of the one or more features (i.e., when the design studio application 102 is having ability to add the one or more custom features and to include the one or more devices). In an embodiment, the design studio application 102 may support network topologies including, but not limited to bus, mesh, ring, star, tree, hybrid topologies, and the like.

For generating the software architecture in the edge computing network, the software architecture generation subsystem 212 is further configured to create the one or more routes by creating the line between the two or more icons corresponding to the one or more components, on the one or more canvas, to establish the one or more connections between the two or more components. In other words, the software architecture generation subsystem 212 is further configured to create the one or more routes quickly and easily by selecting a bubble on the side of any component icon and draw a line to another bubble on another component icon. In an embodiment, drawing of such lines between the two or more components on the one or more canvas enables the one or more users to establish connections between the two or more components. In an embodiment, the one or more routes may indicate one or more communication paths between the two or more components. In an embodiment, each endpoint of the one or more routes is configured to indicate a way in which each component receives one or more information from the one or more components. In another embodiment, each endpoint of the one or more routes is configured to indicate the way in which each component transmits the one or more information to the one or more components.

For generating the software architecture in the edge computing network, the software architecture generation subsystem 212 is further configured to generate the software architecture in the edge computing network upon creation of the one or more routes between the two or more components. On generation of the software architecture in the edge computing network, the software architecture generation subsystem 212 is further configured to store the generated software architecture upon completion of the generation process of the software architecture. In an embodiment, the generated software architecture may be stored in order to further be duplicated and used for similar use cases. In an embodiment, the generated software architecture is configured as a reference software architecture for creating one or more identical variants of the software architecture to support one or more identical configurations. In an embodiment, the software architecture may be duplicated or copied. In another embodiment, the software architecture may be updated and then saved or duplicated.

The plurality of subsystems 110 includes the software architecture processing subsystem 214 that is communicatively connected to the one or more hardware processors 204. The software architecture processing subsystem 214 is configured to process the generated and stored software architecture in the edge computing network to generate one or more installation plans and automatically create corresponding scripts, for installing the software architecture. In other words, the software architecture processing subsystem 214 is configured to enable a push button processing approach of the software architecture to generate the one or more installation plans, for automating the process of creating all the necessary scripts used to install the software architecture. The one or more installation plans further configure each of the one or more components of the architecture including the one or more routes between the one or more components.

In an embodiment, the installation plan may also specify the dependencies of the software architecture so that other components not explicitly specified in the GUI are installed along with the software architecture. On generation of the software architecture, the software architecture is processed with the push of a button on the GUI by the software architecture processing subsystem 214. Processing of the software architecture automatically generates a complete description of the software architecture in a standardized format, for example, JSON and the like. The JSON description generates an Abstract Syntax Tree (AST) that captures all the information generated by the one or more users when designing the software architecture. The Abstract Syntax tree corresponds to the internal representation of the information generated by the one or more users. Processing of the software architecture automatically generates the installation plan including all the scripts needed to install the software architecture in either a simulated or physical environment, for example, ansible install playbook consisting of multiple ansible install scripts and the like.

The plurality of subsystems 110 includes the software architecture execution subsystem 216 that is communicatively connected to the one or more hardware processors 204. The software architecture execution subsystem 216 is configured to execute the generated software architecture in the edge computing network based on at least one of: the simulation-based execution and the physical-based execution. For executing the generated software architecture in the edge computing network based on the simulation-based execution, the software architecture execution subsystem 216 is configured to receive one or more information associated with at least one of: number of one or more virtual machines and type of the one or more virtual machines, to create each group of the one or more edge computing nodes. In other words, the software architecture execution subsystem 216 is configured to specify the number and type of virtual machines to create each node group of the one or more edge computing nodes.

The software architecture execution subsystem 216 is configured to execute the generated software architecture onto the one or more virtual machines. In other words, the software architecture execution subsystem 216 is configured to enable the one or more users to push a button to execute the software architecture of the software running on the edge computing network onto the virtual machines. The software architecture execution subsystem 216 is configured to utilize the one or more installation plans to install the generated software architecture, onto the one or more virtual machines. The software architecture execution subsystem 216 is configured to generate one or more statuses for one or more phases of the virtual execution of the generated software architecture.

The one or more Virtual Machines (VM) may be defined as an emulation of the computer systems in computing. The one or more Virtual Machines are based on computer architectures. The VM's provide the functionality of physical computers. The implementation of VM may consider specialized software, hardware, or a combination thereof. Additionally, the software architecture execution subsystem 216 is configured to generate the status for the various phases of deployment.

For executing the generated software architecture in the edge computing network based on the physical-based execution, the software architecture execution subsystem 216 is configured to receive one or more information associated with at least one of: number of one or more physical devices and type of the one or more physical devices, to create each group of the one or more edge computing nodes. In other words, the software architecture execution subsystem 216 is configured to specify the number and type of physical machines to create each node group. The software architecture execution subsystem 216 is configured to receive one or more information associated with at least one of: the one or more physical devices, a set of protocols to be followed for configuration, one or more device addresses, and one or more configuration parameters, to connect to the one or more physical devices. In other words, the software architecture execution subsystem 216 is configured to enable the one or more users to specify the one or more physical devices (e.g., the one or more sensors and the one or more actuators) to connect, a set of protocols to be followed, device addresses to connect, various configuration parameters, and the like.

The software architecture execution subsystem 216 is configured to execute the generated software architecture onto the one or more physical devices. In other words, the software architecture execution subsystem 216 is configured to enable the one or more users to push a button to execute the software architecture of the software running on the edge computing network onto the one or more physical devices. The software architecture execution subsystem 216 is configured to utilize the one or more installation plans to install the generated software architecture, onto the one or more physical devices. The software architecture execution subsystem 216 is configured to generate one or more statuses for one or more phases of the physical execution of the generated software architecture.

The plurality of subsystems 110 includes the output subsystem 218 that is communicatively connected to the one or more hardware processors 204. The output subsystem 218 is configured to provide the output of at least one of: the installation progress and installation status, the one or more properties, the one or more configuration details, and functioning status, of the generated software architecture, on the graphical user interface associated with the one or more electronic devices 104 associated with the one or more users. In an embodiment, the data output subsystem 218 may include a GUI screen of the design studio application 102 that displays one or more parameters with relevance to the node groups, the one or more micro clouds, one or more physical devices, the one or more routes, and the like, in order to enable the design studio application 102 to be user friendly and easy to use by a person lesser skilled in the art of network creation and management.

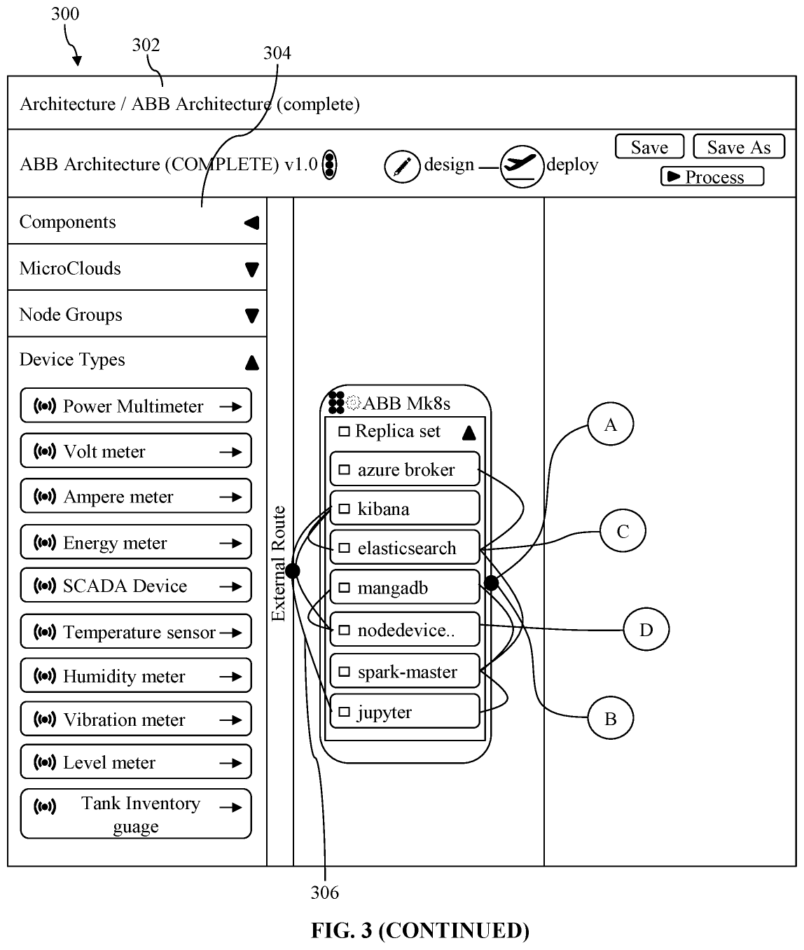

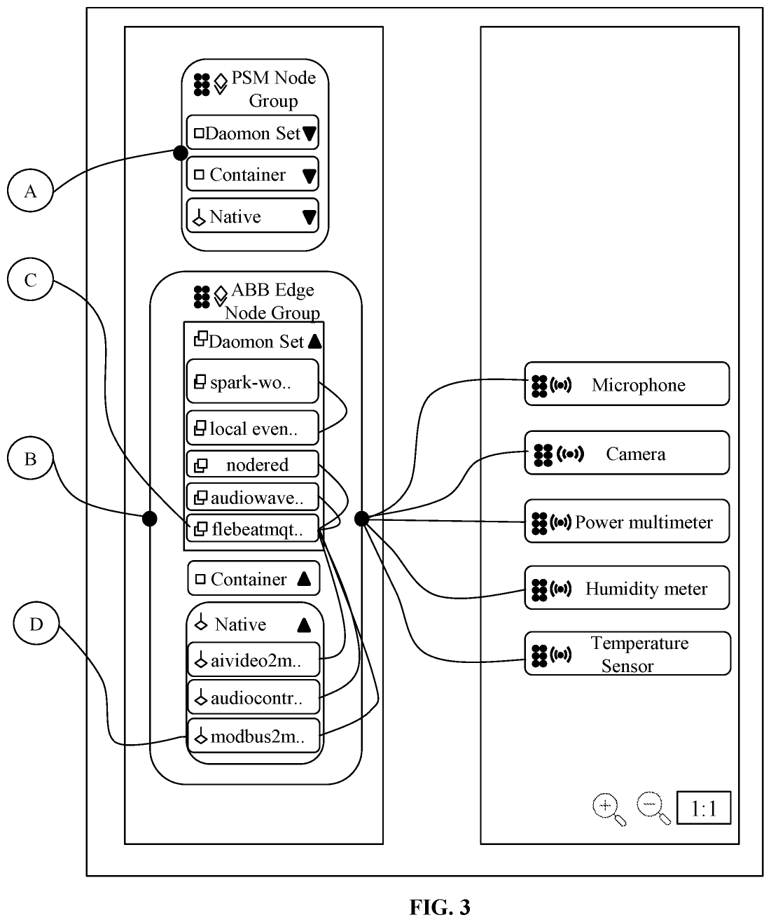

FIG. 3 is a diagrammatic illustration of an exemplary Graphical User Interface (GUI) screen 300 of the design studio application 102, in accordance with an embodiment of the present disclosure. The GUI screen 300 comprises of an architecture task bar 302 on the left end comprising of the one or more components, categorized in various categories 304. The right side of the GUI screen 300 includes the one or more canvas. The one or more canvas corresponds to the area on the GUI screen 300 designated to the one or more users to design the software architecture of the software running on the edge computing network. The one or more canvas is further categorized into micro clouds, node groups and device types. The one or more users are enabled to configure the one or more routes 306 to the one or more selected components placed on the one or more canvas by the design studio application 102.

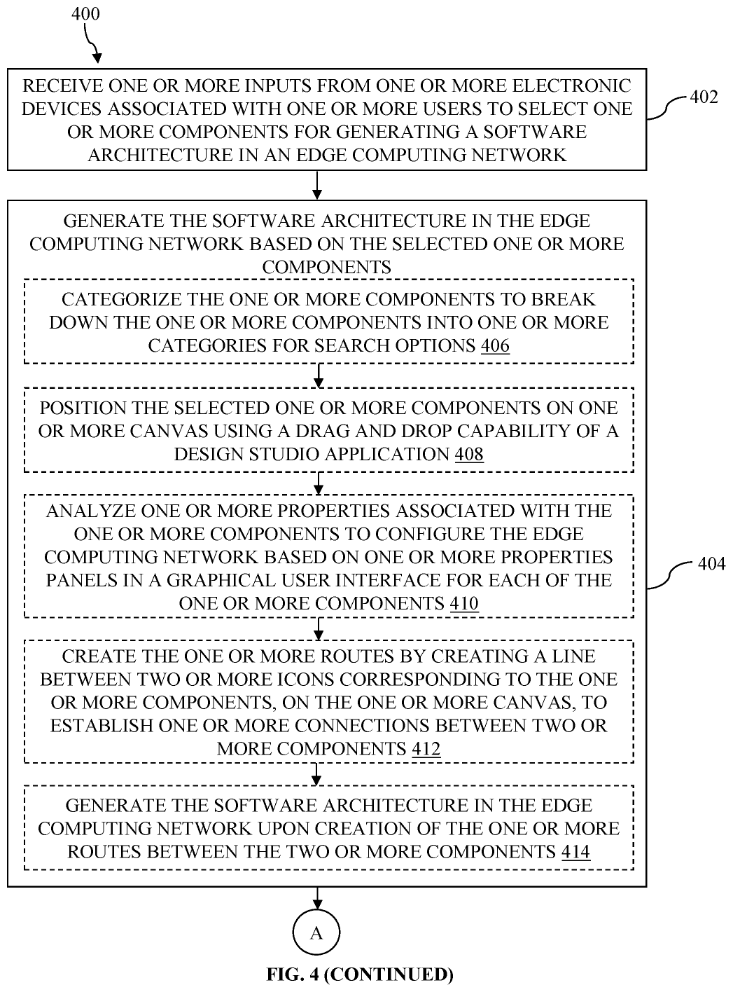

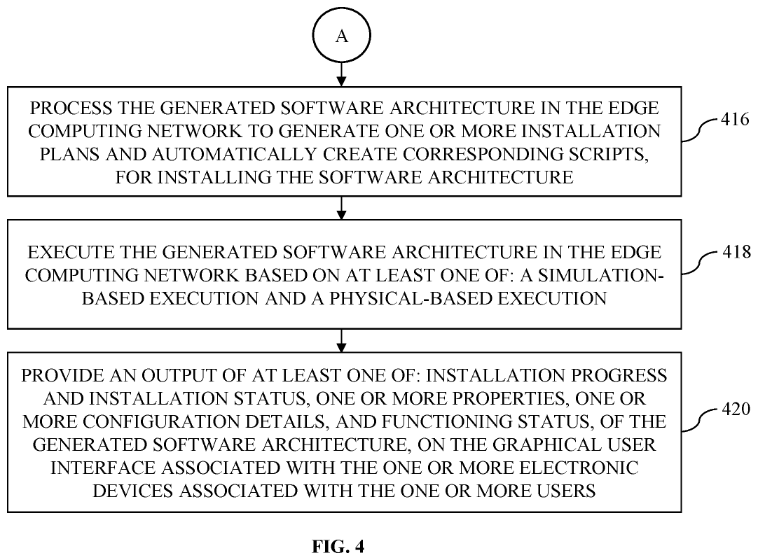

FIG. 4 is a flow chart illustrating a computer-implemented method 400 for generating the software architecture of the software running on the edge computing network based on the design studio application 102, in accordance with an embodiment of the present disclosure.

At step 402, the one or more inputs are received from the one or more electronic devices 104 associated with the one or more users to select the one or more components for generating the software architecture in the edge computing network. In an embodiment, the one or more components may include the one or more physical devices, the one or more groups of the one or more edge computing nodes performing identical roles in the software architecture, the one or more features, the one or more categories of the one or more features, the one or more configurations of the one or more features, the one or more routes indicating the one or more connections between the one or more features for communicating with each feature, and the one or more clouds configured across the one or more groups of the one or more edge computing nodes.

At step 404, the software architecture is generated in the edge computing network based on the one or more components. For generating the software architecture in the edge computing network, the one or more components are categorized to break down the one or more components into one or more categories for search options, as shown in step 406. In an embodiment, the one or more components comprise the one or more icons corresponding to the one or more components for dragging and dropping the one or more components within the edge computing network.

For generating the software architecture in the edge computing network, the selected one or more components are positioned on one or more canvas using a drag and drop capability of the design studio application 102, as shown in step 408.

For generating the software architecture in the edge computing network, the one or more properties associated with the one or more components are analyzed to configure the edge computing network based on one or more properties panels in a graphical user interface for each of the one or more components, as shown in step 410.

For generating the software architecture in the edge computing network, the one or more routes are generated by creating the line between the two or more icons corresponding to the one or more components, on the one or more canvas, to establish the one or more connections between two or more components, as shown in step 412. In an embodiment, the one or more routes may indicate the one or more communication paths between the two or more components.

At step 414, the software architecture is generated in the edge computing network upon creation of the one or more routes between the two or more components.

At step 416, the generated software architecture in the edge computing network is processed to generate the one or more installation plans and automatically create the corresponding scripts, for installing the software architecture.

At step 418, the generated software architecture in the edge computing network is executed based on at least one of: the simulation-based execution and the physical-based execution.

At step 420, the output of at least one of: the installation progress and installation status, the one or more properties, the one or more configuration details, and functioning status, of the generated software architecture, is provided on the graphical user interface associated with the one or more electronic devices 104 associated with the one or more users.

The present invention has following advantages. The design studio application 102, includes the GUI that makes the computer-implemented system much easier to generate/design the software architecture of the software running on the edge computing network. The design studio application 102, is simple to configure. The one or more cloud features with Helm charts are notoriously complex with sometimes thousands of configuration parameters to select from. The design studio application 102 enables an expert to identify the smaller set of relevant configuration parameters and surface/display the configuration parameters in the GUI making it simpler and faster to configure the one or more features. Further, the design studio application 102 enable the one or more users to start from an existing reference software architecture, saving time and reducing the amount of expertise required to successfully architect the system. Furthermore, the design studio application 102 enables automatic dependency management.

The automatic dependency management corresponds to the automatic generation of installation plans greatly simplifying and accelerating the deployment process. Additionally, the design studio application 102 enables the one or more users to easily deploy/execute the software architecture to either a simulated-based or physical-based environment. Deploying to a simulated environment enables testing the software architecture of the software running on the edge computing network without any actual physical compute nodes or devices. Deploying to a physical environment is complex and requires various custom scripts to custom configurations in order to deploy to physical compute nodes and devices from a variety of manufacturers.

The design studio application 102 may speed and simplify the design and deployment of the software architecture of the software running on the edge computing network. Further, the design studio application 102 may further speed and simplify the design and deployment of an edge computing solution. An edge computing solution includes any application running at the edge, a machine learning model running at the edge and the like. Furthermore, the design studio application 102 enables the one or more users to quickly and easily pick the set of components that make up the software architecture of an edge computing network or edge computing solution and compose the software architecture on the one or more canvas with drag and drop capability.

Further, the design studio application 102 enables the one or more users to route the one or more components quickly and easily with each other by connecting components together using a GUI rather than editing a set of files or writing custom scripts to accomplish the same goal. Additionally, the design studio application 102 enables the one or more users to quickly and easily configure the set of components that make up the software architecture of the software running on the edge computing network or edge computing solution in a GUI rather than having to edit complex and non-intuitive configuration files. Furthermore, the design studio application 102 enables the one or more users to configure a deployment plan quickly and easily for a complex software architecture of the software running on the edge computing network or the edge computing solution.

The design studio application 102 is applicable to computer fields, industry fields, and the like. The computer fields in which the design studio application 102 is applicable include edge computing, IoT, orchestration platforms, and the like. The industry fields in which the design studio application 102 determines applications include power and electrification grids, EV charging, manufacturing of any kind where equipment is used, smart buildings, shipping, many other markets that require computing at the distributed edge and the like. However, it is noted that the applicability of the design studio application 102 is not restricted to the above-mentioned fields or domains.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the computer-implemented system either directly or through intervening I/O controllers. Network adapters may also be coupled to the computer-implemented system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer-implemented system in accordance with the embodiments herein. The computer-implemented system herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the computer-implemented system. The computer-implemented system can read the inventive instructions on the program storage devices and follow these instructions to execute the methodology of the embodiments herein.

The computer-implemented system further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A computer-implemented method for generating software architecture in an edge computing network based on a design studio application, the computer-implemented method comprising:
receiving, by one or more hardware processors, one or more inputs from one or more electronic devices associated with one or more users to select one or more components for generating the software architecture in the edge computing network, wherein the one or more components comprise at least one of: one or more physical devices, one or more groups of one or more edge computing nodes performing identical roles in the software architecture, one or more features, one or more categories of the one or more features, one or more configurations of the one or more features, one or more routes indicating one or more connections between the one or more features for communicating with each feature, and one or more clouds configured across the one or more groups of the one or more edge computing nodes;
generating, by the one or more hardware processors, the software architecture in the edge computing network based on the selected one or more components, wherein generating the software architecture in the edge computing network based on the selected one or more components comprises at least one of:
categorizing, by the one or more hardware processors, the one or more components to break down the one or more components into one or more categories for search options, wherein the one or more components comprise one or more icons corresponding to the one or more components for dragging and dropping the one or more components within the edge computing network;
positioning, by the one or more hardware processors, the selected one or more components on one or more canvas using a drag and drop capability of the design studio application;
analyzing, by the one or more hardware processors, one or more properties associated with the one or more components to configure the edge computing network based on one or more properties panels in a graphical user interface for each of the one or more components;
creating, by the one or more hardware processors, the one or more routes by creating a line between two or more icons corresponding to the one or more components, on the one or more canvas, to establish one or more connections between two or more components, wherein the one or more routes indicate one or more communication paths between the two or more components; and
generating, by the one or more hardware processors, the software architecture in the edge computing network upon creation of the one or more routes between the two or more components;
processing, by the one or more hardware processors, the generated software architecture in the edge computing network to generate one or more installation plans and automatically create corresponding scripts, for installing the software architecture;
executing, by the one or more hardware processors, the generated software architecture in the edge computing network based on at least one of: a simulation-based execution and a physical-based execution;
providing, by the one or more hardware processors, an output of at least one of: installation progress and installation status, one or more properties, one or more configuration details, and functioning status, of the generated software architecture, on the graphical user interface associated with the one or more electronic devices associated with the one or more users.

2. The computer-implemented method of claim 1, further comprising displaying, by the one or more hardware processors, the one or more properties associated with the selected one or more components for configuring the one or more components to obtain an optimized edge computing network.

3. The computer-implemented method of claim 1, further comprising updating, by the one or more hardware processors, one or more configurations of the edge computing network based on the analysis of the one or more properties associated with the one or more components, upon selecting the one or more components.

4. The computer-implemented method of claim 1, further comprising at least one of:
configuring, by the one or more hardware processors, each endpoint of the one or more routes to indicate a way in which each component receives one or more information from the one or more components; and
configuring, by the one or more hardware processors, each endpoint of the one or more routes to indicate the way in which each component transmits the one or more information to the one or more components.

5. The computer-implemented method of claim 1, further comprising storing, by the one or more hardware processors, the generated software architecture upon completion of the generation process of the software architecture,
wherein the generated software architecture is configured as a reference software architecture for creating one or more identical variants of the software architecture to support one or more identical configurations.

6. The computer-implemented method of claim 1, wherein executing, by the one or more hardware processors, the generated software architecture in the edge computing network based on the simulation-based execution, comprises:
receiving, by the one or more hardware processors, one or more information associated with at least one of: number of one or more virtual machines and type of the one or more virtual machines, to create each group of the one or more edge computing nodes;
executing, by the one or more hardware processors, the generated software architecture onto the one or more virtual machines;
utilizing, by the one or more hardware processors, the one or more installation plans to install the generated software architecture, onto the one or more virtual machines; and
generating, by the one or more hardware processors, one or more statuses for one or more phases of the virtual execution of the generated software architecture.

7. The computer-implemented method of claim 1, wherein executing, by the one or more hardware processors, the generated software architecture in the edge computing network based on the physical-based execution, comprises:
receiving, by the one or more hardware processors, one or more information associated with at least one of: number of one or more physical devices and type of the one or more physical devices, to create each group of the one or more edge computing nodes;
receiving, by the one or more hardware processors, one or more information associated with at least one of: the one or more physical devices, a set of protocols to be followed for configuration, one or more device addresses, and one or more configuration parameters, to connect to the one or more physical devices;
executing, by the one or more hardware processors, the generated software architecture onto the one or more physical devices;
utilizing, by the one or more hardware processors, the one or more installation plans to install the generated software architecture, onto the one or more physical devices; and
generating, by the one or more hardware processors, one or more statuses for one or more phases of the physical execution of the generated software architecture.

8. A computer-implemented system for generating software architecture in an edge computing network based on a design studio application, the computer-implemented system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
an input receiving subsystem configured to receive one or more inputs from one or more electronic devices associated with one or more users to select one or more components for generating the software architecture in the edge computing network, wherein the one or more components comprise one or more physical devices, one or more groups of one or more edge computing nodes performing identical roles in the software architecture, one or more features, one or more categories of the one or more features, one or more configurations of the one or more features, one or more routes indicating one or more connections between the one or more features for communicating with each feature, and one or more clouds configured across the one or more groups of the one or more edge computing nodes;
a software architecture generation subsystem configured to generate software architecture, wherein in generating the software architecture in the edge computing network based on the one or more components, the software architecture generation subsystem is configured to:
categorize the one or more components to break down the one or more components into one or more categories for search options, wherein the one or more components comprise one or more icons corresponding to the one or more components for dragging and dropping the one or more components within the edge computing network;
position the selected one or more components on one or more canvas using a drag and drop capability of the design studio application;
analyze one or more properties associated with the one or more components to configure the edge computing network based on one or more properties panels in a graphical user interface for each of the one or more components;
create the one or more routes by creating a line between two or more icons corresponding to the one or more components, on the one or more canvas, to establish one or more connections between two or more components, wherein the one or more routes indicate one or more communication paths between the two or more components; and
generate the software architecture in the edge computing network upon creation of the one or more routes between the two or more components;
a software architecture processing subsystem configured to process the generated software architecture in the edge computing network to generate one or more installation plans and automatically create corresponding scripts, for installing the software architecture;
a software architecture execution subsystem configured to execute the generated software architecture in the edge computing network based on at least one of: a simulation-based execution and a physical-based execution;
an output subsystem configured to provide an output of at least one of: installation progress and installation status, one or more properties, one or more configuration details, and functioning status, of the generated software architecture, on the graphical user interface associated with the one or more electronic devices associated with the one or more users.

9. The computer-implemented system of claim 8, wherein the software architecture generation subsystem is further configured to display the one or more properties associated with the selected one or more components for configuring the one or more components to obtain an optimized edge computing network.

10. The computer-implemented system of claim 8, wherein the software architecture generation subsystem is further configured to update one or more configurations of the edge computing network based on the analysis of the one or more properties associated with the one or more components, upon selection of the one or more components.

11. The computer-implemented system of claim 8, wherein at least one of:
each endpoint of the one or more routes is configured to indicate a way in which each component receives one or more information from the one or more components; and
each endpoint of the one or more routes is configured to indicate the way in which each component transmits the one or more information to the one or more components.

12. The computer-implemented system of claim 8, wherein the software architecture generation subsystem is further configured to store the generated software architecture upon completion of the generation process of the software architecture, and
wherein the generated software architecture is configured as a reference software architecture for creating one or more identical variants of the software architecture to support one or more identical configurations.

13. The computer-implemented system of claim 8, wherein in executing the generated software architecture in the edge computing network based on the simulation-based execution, the software architecture execution subsystem is configured to:
receive one or more information associated with at least one of: number of one or more virtual machines and type of the one or more virtual machines, to create each group of the one or more edge computing nodes;
execute the generated software architecture onto the one or more virtual machines;
utilize the one or more installation plans to install the generated software architecture, onto the one or more virtual machines; and
generate one or more statuses for one or more phases of the virtual execution of the generated software architecture.

14. The computer-implemented system of claim 8, wherein in executing the generated software architecture in the edge computing network based on the physical-based execution, the software architecture execution subsystem is configured to:
receive one or more information associated with at least one of: number of one or more physical devices and type of the one or more physical devices, to create each group of the one or more edge computing nodes;
receive one or more information associated with at least one of: the one or more physical devices, a set of protocols to be followed for configuration, one or more device addresses, and one or more configuration parameters, to connect to the one or more physical devices;
execute the generated software architecture onto the one or more physical devices;
utilize the one or more installation plans to install the generated software architecture, onto the one or more physical devices; and
generate one or more statuses for one or more phases of the physical execution of the generated software architecture.

15. A non-transitory computer-readable storage medium having instructions stored therein that when executed by one or more hardware processors, cause the one or more hardware processors to execute operations of:
receiving one or more inputs from one or more electronic devices associated with one or more users to select one or more components for generating the software architecture in the edge computing network, wherein the one or more components comprise one or more physical devices, one or more groups of one or more edge computing nodes performing identical roles in the software architecture, one or more features, one or more categories of the one or more features, one or more configurations of the one or more features, one or more routes indicating one or more connections between the one or more features for communicating with each feature, and one or more clouds configured across the one or more groups of the one or more edge computing nodes;
generating the software architecture in the edge computing network based on the selected one or more components, wherein generating the software architecture in the edge computing network based on the selected one or more components comprises at least one of:
categorizing the one or more components to break down the one or more components into one or more categories for search options, wherein the one or more components comprise one or more icons corresponding to the one or more components for dragging and dropping the one or more components within the edge computing network;
positioning the selected one or more components on one or more canvas using a drag and drop capability of the design studio application;
analyzing one or more properties associated with the one or more components to configure the edge computing network based on one or more properties panels in a graphical user interface for each of the one or more components;
creating the one or more routes by creating a line between two or more icons corresponding to the one or more components, on the one or more canvas, to establish one or more connections between two or more components, wherein the one or more routes indicate one or more communication paths between the two or more components; and
generating the software architecture in the edge computing network upon creation of the one or more routes between the two or more components;
processing the generated software architecture in the edge computing network to generate one or more installation plans and automatically create corresponding scripts, for installing the software architecture;
executing the generated software architecture configuring in the edge computing network based on at least one of: a simulation-based execution and a physical-based execution;
providing an output of at least one of: installation progress and installation status, one or more properties, one or more configuration details, and functioning status, of the generated software architecture, on the graphical user interface associated with the one or more electronic devices associated with the one or more users.

16. The non-transitory computer-readable storage medium of claim 15, further comprising:
displaying the one or more properties associated with the selected one or more components for configuring the one or more components to obtain an optimized edge computing network; and
updating one or more configurations of the edge computing network based on the analysis of the one or more properties associated with the one or more components, upon selecting the one or more components.

17. The non-transitory computer-readable storage medium of claim 15, further comprising at least one of:
configuring each endpoint of the one or more routes to indicate a way in which each component receives one or more information from the one or more components; and
configuring each endpoint of the one or more routes to indicate the way in which each component transmits the one or more information to the one or more components.

18. The non-transitory computer-readable storage medium of claim 15, further comprising storing the generated software architecture upon completion of the generation process of the software architecture,
wherein the generated software architecture is configured as a reference software architecture for creating one or more identical variants of the software architecture to support one or more identical configurations.

19. The non-transitory computer-readable storage medium of claim 15, wherein executing the generated software architecture in the edge computing network based on the simulation-based execution, comprises:
receiving one or more information associated with at least one of: number of one or more virtual machines and type of the one or more virtual machines, to create each group of the one or more edge computing nodes;
executing the generated software architecture onto the one or more virtual machines;
utilizing the one or more installation plans to install the generated software architecture, onto the one or more virtual machines; and
generating one or more statuses for one or more phases of the virtual execution of the generated software architecture.

20. The non-transitory computer-readable storage medium of claim 15, wherein executing the generated software architecture in the edge computing network based on the physical-based execution, comprises:
receiving one or more information associated with at least one of: number of one or more physical devices and type of the one or more physical devices, to create each group of the one or more edge computing nodes;
receiving one or more information associated with at least one of: the one or more physical devices, a set of protocols to be followed for configuration, one or more device addresses, and one or more configuration parameters, to connect to the one or more physical devices;
executing the generated software architecture onto the one or more physical devices;
utilizing the one or more installation plans to install the generated software architecture, onto the one or more physical devices; and
generating one or more statuses for one or more phases of the physical execution of the generated software architecture.
